(19) United States
(12) Patent Application Publication
(10) Pub. No.: US 2007/0098397 A1
(43) Pub. Date: May 3, 2007

(54) Network camera

(75) Inventors: Maggie Chen, Irvine, CA (US); Ah Jee Wang, Irvine, CA (US)

Correspondence Address: BERKELEY LAW & TECHNOLOGY GROUP, LLP, 1700 NW 167TH PLACE, SUITE 240, BEAVERTON, OR, 97006, US

(73) Assignee: D-Link Systems, Inc.

(21) Appl. No.: 11/264,927

(22) Filed: Nov. 1, 2005

(51) Int. Cl. G03B 19/00

(52) U.S. Cl. 396/429

(57) ABSTRACT

A camera capable of transmitting image data to devices on a network is disclosed.

### BACKGROUND

1. Field

Subject matter disclosed herein relates to the capture and transmission of images.

2. Information

Television sets are typically capable of presenting images to viewers based upon broadcast signals received from local television stations, cable transmissions, satellite transmissions and/or the like. Additionally, television sets have been capable of presenting image to viewers in response to prerecorded signals from sources such as, for example, video cassette recorders (VCRs), digital video disks (DVDs) and digital video recorders (DVRs). In addition, televisions have been used for presenting images from other sources such as, for example, still images from digital cameras (including cameras on cell phones), and content streamed from the Internet and/or video cameras. Also, digital cameras have been connected to data transmission networks for the transmission and/or distribution of digital images to other devices connected to digital transmission networks.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a schematic diagram of a data communication system according to an embodiment.

FIG. 2 is a schematic diagram of a camera according to an embodiment.

FIG. 3 is a flow diagram illustrating a process executed in connection with a camera according to an embodiment.

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

Some portions of the detailed description which follow may be presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “transforming,” “mapping,” “scaling,” “obtaining,” “selecting,” “converting,” “hosting,”“factoring,” enumerating,” “representing,” “storing,” “associating,” “substituting,”“determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices. Further, unless specifically stated otherwise, processes described herein, with reference to flow diagrams or otherwise, may also be executed and/or controlled, in whole or in part, by such a computing platform. “Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. However, these are merely examples of a storage medium and claimed subject matter is not limited in these respects.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a storage medium in combination with processing circuitry to execute such machine-readable instructions. However, these are merely examples of structures which may provide logic and claimed subject matter is not limited in this respect.

A “presentation” as referred to herein relates to an expression of information in a perceivable medium. In one example, although claimed subject matter is not limited in these respects, a presentation may comprise an environmental stimulus such as, for example, generation of images and/or sounds. Such a presentation may also be directed to a particular audience that is capable of sensing the presentation. As described herein, devices may be capable of “presenting” such expressions based, at least in part, on signals that represent such expressions. However, these are merely examples of presentations and claimed subject matter is not limited in these respects.

A “display” as referred to herein relates to a device that is capable of presenting an image in response to one or more signals. For example, although claimed subject matter is not limited in this respect, a display may comprise an array of pixels in predetermined locations to represent portions of images at these predetermined locations. In one particular embodiment, individual pixel elements may be controlled to illuminate a portion of an image at a particular image location based, at least in part, on one or more signals representing the image. However, these are merely example embodiments of a display and claimed subject matter is not limited in these respects.

A “media device” as referred to herein relates to a device that is capable of generating environmental stimuli such as, for example, sounds and/or images in response to encoded information. For example, a media device may be capable of reproducing video images, music and/or other audio signals based, at least in part, on data which is encoded according to a predetermined encoding format. In one embodiment, a media device may comprise an output device such as, for example, a display and/or speaker for generating environmental stimuli. Alternatively, a media device may not necessarily be comprise such an output device but instead may be capable of being coupled to such an output device to provide one or more signals to the output device for generating environmental stimuli. However, these are merely examples of a media device and claimed subject matter is not limited in these respects.

“Image data” as referred to herein relates to a signal and/or data that is representative of a visual image according to a predefined format. In one particular embodiment, although claimed subject matter is not limited in this respect, image data may represent pixel values at associated locations in an image. In other embodiments, image data may represent a still image or a moving image (e.g., as successive video frames). Image data may also exist in a predefined compressed and/or encoded format. However, these are merely examples of image data and claimed subject matter is not limited in these respects.

A “content signal” or “content data” as referred to herein relates to a signal and/or data comprising information that is representative of environmental stimuli such as sounds and/or visual images. Here, the terms “content signal” and “content data” shall be used interchangeably throughout. In one particular embodiment, for example, a content signal may comprise signals which are encoded according to a predetermined format. Here, for example, a content signal may comprise encoded signals that are representative of audio, video, text and/or still images. However, these are merely examples of a content signal and claimed subject matter is not limited in these respects.

According to an embodiment, a media device may be capable of providing a presentation in response to and/or based on, at least in part, a content signal. In a particular embodiment, for example, a media device may be capable of, by itself or in combination with one or more output devices, displaying images and/or generating sounds which are based, at least in part, on one or more content signals.

According to an embodiment, a content signal may comprise information that is temporally defined with reference to a presentation to an audience. In a particular embodiment, for example, a content signal comprising a video component may comprise sequential frames which are temporally referenced to portions of a video presentation. In another particular embodiment, a content signal comprising an audio component may comprise sequential segments that are temporally referenced to portions of an audio presentation. However, these are merely examples of how a content signal may comprise segments which are temporally referenced to portions of a presentation and claimed subject matter is not limited in these respects.

A “data transmission network” as referred to herein relates to infrastructure that is capable of transmitting data among nodes which are coupled to the data transmission network. For example, a data transmission network may comprise links capable of transmitting data between nodes according to one or more data transmission protocols. Such links may comprise one or more types of transmission media capable of transmitting information from a source to a destination. However, these are merely examples of a data transmission network and claimed subject matter is not limited in these respects.

A “network address” may be associated with a device and/or process that is capable of communicating with a data transmission network. Such a network address may comprise symbols that represent a location of an associated device and/or process on a data transmission network. In particular example, a destination address of a data packet may comprise a network address associated with a destination device and/or process. Using this network address, intermediate nodes in the data transmission network may forward the data packet to a destination associated with the destination network address. In one particular embodiment, although claimed subject matter is not limited in this respect, a network address may have a format defined according to a particular network communication protocol such as the Internet Protocol (IP) where such a network address may be referred to as an “IP address.” Also, a network address may be statically defined for a particular device and/or process. Alternatively, a network address associated with a device and/or process may be dynamically assigned in response to an event such as, for example, the device and/or process joining a data transmission network. It should be understood, however, that these are merely examples of a network address and claimed subject matter is not limited in these respects.

A “local network” as referred to herein relates to a communication network having entities that communicate according to a locally defined data communication protocol. For examples, an entity in a local network may be associated with a “local network address” which is unique among local network addresses assigned to entities in the local network. This may enable entities in the local network to communicate with one another using the assigned local addresses according to a locally defined communication protocol. Using only the assigned local addresses, however, an entity in the local network may be limited to communicating with entities in the local network and may not be capable of communicating with other entities in a larger data transmission network that includes or is coupled to the local network. However, these are merely examples of a local network and embodiments of the present invention are not limited in these respects.

A device connected to a data transmission network may be “discovered” by one or more other devices connected to the data transmission network. Such a discovery of a device may comprise obtaining information identifying the device and one or more functional abilities associated with the device. In one particular example, although claimed subject matter is not limited in these respects, information identifying a device that may be discovered may comprise a unique identifier associated with the device. Here, one or more functional abilities of such a discovered device may be accessible according to such a unique identifier through, for example, a server connected to the discovered device. In another particular example, information identifying a device that may be discovered may comprise a network address associated with the discovered device. Here, one or more functional abilities of such a discovered device may be accessible through routing of one or more request messages directly to the discovered device. It should be understood, however, that this is merely an example of how a device on a data transmission network may interact with one or more other “discovered” devices coupled to the data transmission network, and claimed subject matter is not limited in these respects.

A computing platform may employ different types of information storage devices based, at least in part, on information storage capacity needs, access speed performance, cost, power consumption among other considerations. A “mass storage device” as referred to herein relates to one or more storage devices for storing large quantities of information. In one particular embodiment, although claimed subject matter is not limited in this respect, a computing platform may tolerate slower access speeds of a mass storage device than with other execution critical storage devices such as, for example, system memory and/or cache memory. In particular examples, a mass storage device may comprise one or more magnetic disks, magnetic tape, dense flash memory, compact disks and/or the like. However, these are merely examples of mass storage devices and claimed subject matter is not limited in these respects.

A “file storage device” as referred to herein relates to one or more storage devices that are capable of storing files in a retrievable format. In one particular example, although claimed subject matter is not limited in this respect, files stored on a file storage device may be associated with corresponding file names. Such files may be organized by file names in one or more file directories having, for example, a hierarchical data structure. In one particular embodiment, although claimed subject matter is not limited in this respect, a file storage device may comprise one or more mass storage devices for storing retrievable files. However, these are merely examples of how a file storage device may be implemented and claimed subject matter is not limited in this respect.

A “communication adapter” as referred to herein relates to one or more devices capable of transmitting and/or receiving information from a communication channel and/or data link. In one particular embodiment, for example, a communication adapter may be capable of transmitting information to and/or receiving information from a data transmission medium according to a predefined communication protocol. However, this is merely an example of a communication adapter and claimed subject matter is not limited in this respect.

A “server” as referred to herein relates to one or more devices and/or one or more processes on a network that manage and/or control network resources. For example, a file server may comprise a computer and storage device for storing files. Accordingly, client users may store files on and/or retrieve files from the file server by accessing the network. Similarly, a server may store content data on one or more storage devices. Here, a client user may obtain the stored content data by accessing a network that communicates with the server. In other embodiments, a server may comprise software in the form of machine-readable instructions enabling the storage of files and/or content for access as illustrated above. However, these are merely examples of a server and claimed subject matter is not limited in these respects.

According to an embodiment, a content signal may be transmitted from a source to a destination by “streaming” the content signal whereby a first temporally referenced portion of the content signal is presented at a media device while a subsequent temporally referenced portion is being contemporaneously transmitted and/or delivered to the media device for subsequent presentation. In a particular embodiment, for example, a media device may display images, by itself or in combination with one or more output devices, of a leading portion of a streamed video signal while a trailing portion of the video signal is being transmitted and/or delivered to the media device. Similarly, a media device may generate sounds based, at least in part, on a leading portion of a streamed audio signal while a trailing portion of the audio signal is being transmitted and/or delivered to the media device. However, these are merely examples of how a content signal may be streamed to a media device and claimed subject matter is not limited in these respects.

A “camera” as referred to herein relates to a device for capturing an image in response to light received on a surface. In one particular example, a camera may comprise lenses and/or other optical system to focus light from an object onto an imaging device or imager that is capable of capturing the focused light as a digital and/or analog information. However, this is merely an example of a camera and claimed subject matter is not limited in these respects.

According to an embodiment, a camera may be adapted to capture images and transmit image data to one or more destinations over a data transmission network. In one particular embodiment, a device may address request messages to a camera according to a network address associated with the camera requesting transmission of image data to the requesting device. Prior to transmitting such request messages, the requesting device may determine the network address of the camera in response to either the camera or the requesting device joining the data transmission network. However, this merely an example embodiment and claimed subject matter is not limited in these respects.

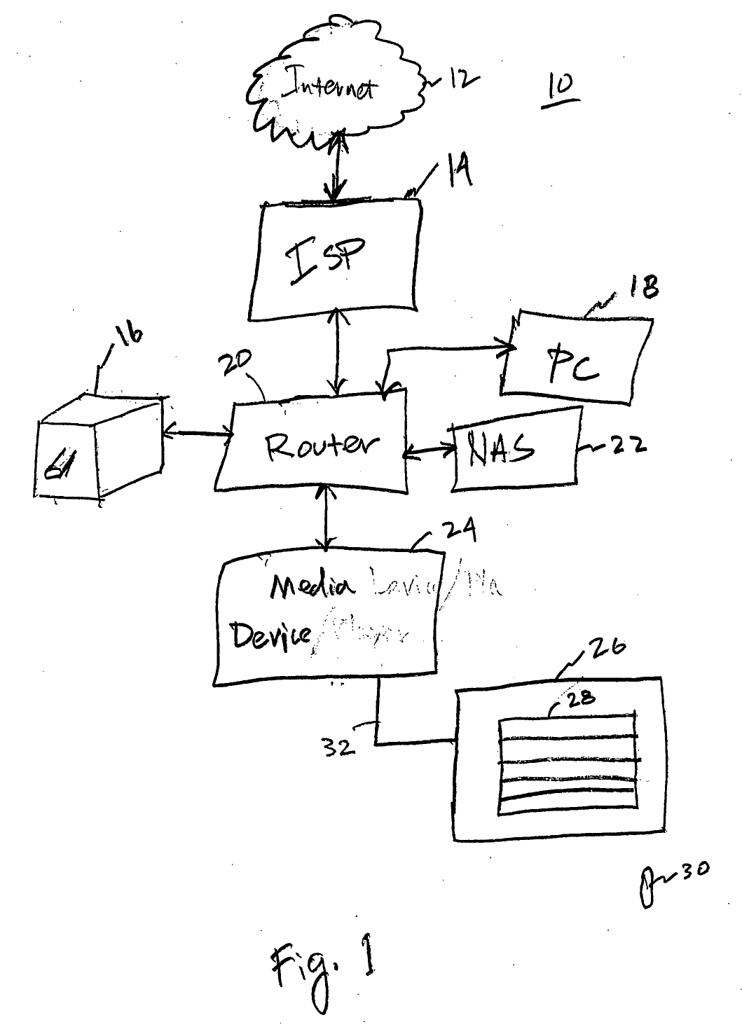

FIG. 1 is a schematic diagram of a system 10 to present images on a display 26 based, at least in part, image data according to an embodiment. A router 20 may transmit data between devices in system 10 over data links comprising a wireless transmission air interface and/or cabling (e.g., optical, coaxial and/or twisted wire pair cabling) according to any one of several data transmission protocols such as, for example, versions of IEEE Std. 802.3 or IEEE Std. 802.11, universal serial bus (USB), Firewire, Bluetooth and/or the like. However, these are merely examples of data transmission protocols that may be used to transmit image data over a data link and claimed subject matter is not limited in these respects.

Router 20 may enable the transmission of data packets among devices, such as camera 16, personal computer (PC) 18 network attached storage (NAS) appliance 22 and/or media device 24 according to a communication protocol. As such, these devices may be associated with a network address enabling router 20 to route and/or forward data packets to destination devices based, at least in part, on a network address provided in data packets to be forwarded. In one particular embodiment, although claimed subject matter is not limited-in this respect, router 20 may be capable of forwarding data packets to one or more of these devices according to the aforementioned Internet Protocol (IP). Here, a device coupled to router 20, such as camera 16, for example, may be associated with a network address comprising an IP address to enable forwarding of data packets to camera 16 according to the IP address. For example, upon receipt of a data packet addressed to the IP address associated with camera 16, router 20 may forward the received data packet on an output port (not shown) that is adapted to transmit data packets to camera 16. According to an embodiment, system 10 may be capable of integrating camera 16, PC 18, NAS 22 and/or media device 24 as elements of a Universal Plug and Play Audio Visual (UPnP AV) architecture as illustrated in UPnP AV Architecture: 0.83 for UPnP Version 1.0, UPnP Forum, Jun. 12, 2002. However, this is merely an example of how devices may be integrated on a data transmission network and claimed subject matter is not limited in these respects.

According to an embodiment, media device 24 may comprise any one of several devices capable of generating environmental stimuli, either by itself or in combination with an output device. For example, media device 24 may comprise a computing platform that is capable of processing image data. In particular embodiments, although claimed subject matter is not limited in these respects, media device 24 may comprise a home entertainment appliance, a personal computer, a handheld device and/or the like. However, these are merely examples of platforms that may comprise a media device and claimed subject matter is not limited in these respects.

According to an embodiment, media device 24 is capable of generating a presentation on media output device such as display 26 in response to content data received from devices coupled to router 20. In particular embodiments, camera 16, PC 18 and/or NAS appliance 22 may be capable of streaming content data to media device 24 for presenting and/or rendering an image onto a media output device. For example, media device 24 may be capable of receiving and/or processing content data in any one of several encoded formats such as, for example, MP3, WMA, OGG, WAV, AIFF, ReadAudio,GIF, TIFF, JPEG, JPEG2000, BMP, PNG, MPEG1/2/4, WMV, H.263, H.264, VC-1, DivX, Xvid, Real Video, Nero Digital, QuickTime and/or the like. However, these are merely examples of formats that may be used for expressing content data and claimed subject matter is not limited in these respects. In particular embodiments, although claimed subject matter is not limited in these respects, media device 24 may comprise circuitry and/or logic for transcoding content data to provide a video signal on cable for presenting images on display 26. Such a video signal may be provided in any one of several television signal formats such as, for example, Standard Definition (SD) format (e.g., including NTSC and/or PAL formats) and/or High Definition Television (HDTV) formats. However, these are merely examples of particular signal formats that may be used for transmitting a video signal to a display and claimed subject matter is not limited in these respects.

Media device 24 may be responsive to inputs from a remote control 30 to select content for presentation on display 26. Remote control 30 may be capable of providing such inputs to media device 24 over wireless transmission link capable of transmitting information in radio frequency, infrared and/or magnetic signals, for example, between media device 24 and remote control 30. However, this is merely an example of how a media device may receive control inputs from a user and claimed subject matter is not limited in these respects. In a particular embodiment, although claimed subject matter is not limited in this respect, remote control 30 may be used in combination with display 26 as graphical user interface (GUI) for provide inputs to media device 24. Here, for example, a user may manipulate remote control 30 to navigate options shown on a menu 28 presented on display 26. In one embodiment, a user may maneuver a cursor and/or illuminate items on a menu. The user may then press a button and/or actuate other items on remote control 30 to select an illuminated item, thereby sending a control signal to media device 24 to make the selection. However, this is merely an example of how a user may provide a control signal to a media device using a remote control in combination with a display and claimed subject matter is not limited in these respects. In alternative embodiment, media device 24 may respond to inputs from a user interface other than a remote control device such as, for example, a keyboard, control panel and/or user interface (not shown) connected to media device 24. Again, this is merely another example of how a media device may receive a user input and claimed subject matter is not limited in these respects.

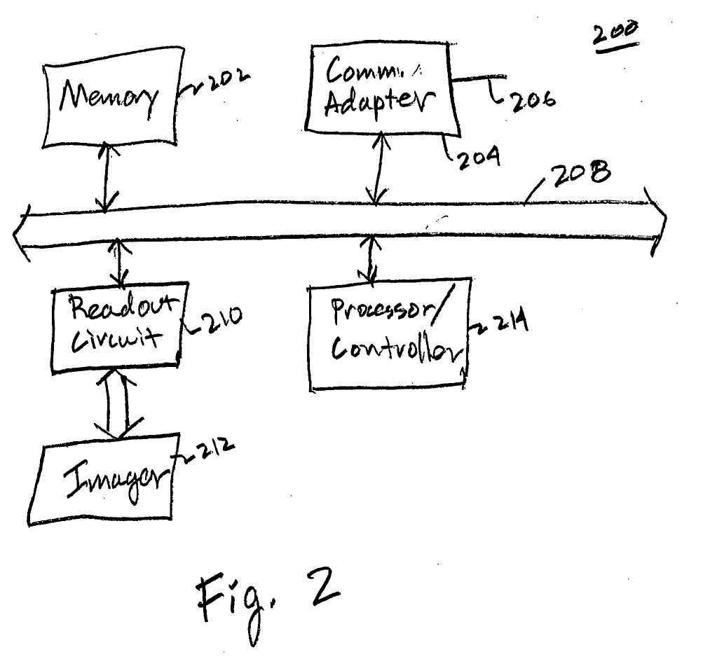

FIG. 2 is a schematic diagram of a camera 200 according to an embodiment of camera 16. Bus 208 may be connected to devices to enable inter-device communication. In addition to comprising bus signaling lines according to a particular embodiment, bus 208 may also comprise one or more devices providing core logic enabling devices to communicate with one another over particular device interfaces connecting the devices to bus 208. However, this is merely an example of how devices may be integrated within a camera and claimed subject matter is not limited in this respect.

A communication adapter 204 may transmit image data to a data transmission network in data packets and/or data frames according to any of the aforementioned communication protocols. Communication adapter 204 may comprise, for example, a physical layer transceiver connected to a data transmission medium 206 and/or a media access controller capable of receiving data packets and/or data frames transmitted according to a data link protocol such as, for example, versions of IEEE Std. 802.11, IEEE Std. 802.16, IEEE Std. 802.3, USB, Firewire, Bluetooth, cellular telephony protocols and/or the like. However, these are merely examples of how a communication adapter may receive data packets in a data link and claimed subject matter is not limited in these respects. In one example, data transmission medium 206 may comprise twisted pair cabling such as category 5 cabling to transmit data to and from camera 200 according to a 10/100 BASE-T protocol. Here, in one particular embodiment, although claimed subject matter is not limited in these respects, camera 200 may receive a power signal from data transmission medium according to IEEE Std. 802.3 af-2003 for powering portions of camera 200 such as devices connected to bus 208.

Memory 202 may comprise one or more devices capable of providing a volatile and/or non-volatile memory such as, for example, random access memory (RAM), flash memory, hard drive, optical storage devices and/or the like. In one embodiment, although claimed subject matter is not limited in these respects, communication adapter 204 may store information from received data packets in predetermined buffer locations of memory 202 using direct memory access transactions via bus 208. However, this is merely an example of how a communication adapter may store information received in data packets and claimed subject matter is not limited in these respects.

According to an embodiment a processor/controller 214 may comprise processing circuitry for executing machine-readable instructions stored in memory 202 to perform tasks such as, for example, embedded applications processing, Internet Protocol processing, HTTP and/or UPnP protocol processing, and/or processing of user inputs. In particular embodiments, although claimed subject matter is not limited in this respect, processor/controller 214 may comprise processing circuitry formed according to any one of several commercially available processing cores such as, for example, ARM or MIPS processing cores.

According to an embodiment, camera 200 may capture images of objects onto an imager 212. Camera 200 may also comprise one or more lenses (not shown) for focusing images of objects onto imager 212 using techniques known to those of ordinary skill in the art of digital photography. Imager 212 may comprise a substrate capable of capturing light energy on specific pixel regions. Imager 212 may comprise any one of several devices for capturing light energy on pixel regions such as, for example, a CMOS imager and/or charged coupled device. However, these are merely examples of devices that may be used for capturing light energy and claimed subject matter is not limited in these respects.

A readout circuit 210 may measure and/or record light intensities on individual pixel regions of imager 212. Here, readout circuit 210 may format such measurements of light intensities on pixel regions to provide a digital representation of a two-dimensional image. Processor/controller 214 and/or a dedicated encoding device (not shown) may encode and/or compress the digital representations for storage in memory 202 according to any one of several formats such as, for example, GIF, TIFF, JPEG, JPEG2000, BMP, PNG, MPEG1/2/4, WMV, H.263, H.264, VC-1, DivX, Xvid, Real Video, Nero Digital, QuickTime and/or the like. However, these are merely examples of formats that may be used in encoding and/or compressing image data and claimed subject matter is not limited in these respects. In some embodiments, although claimed subject matter is not limited in these respects, processor/controller 214 and/or a dedicated encoding device may also encoded audio data for transmission in any one of several formats such as, for example, MP3, WMA, WAV, AIFF, OGG and RealAudio, just to name a few.

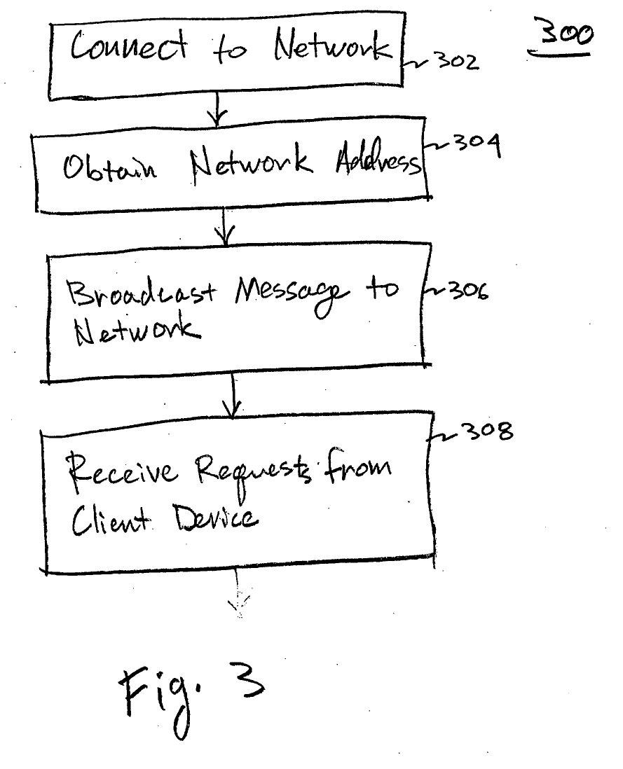

As pointed out above, camera 200 may transmit image data to a data transmission network through communication adapter 204. Such image data may be generated at least in part from images captured at imager 212 as illustrated above. In particular embodiments, although claimed subject matter is not limited in these respects, camera 200 may stream image data captured at imager 212 to one or more devices coupled to a data transmission network in real-time. FIG. 3 is a flow diagram illustrating a process 300 to enable transmission of image data to a data transmission network according to an embodiment of camera 200. Process 300 may be initiated by connecting a camera to a data transmission network at block 302. In this context, “connecting” a device to a data transmission network comprises establishing a communication link between the device and the data transmission network over a data transmission medium such as, for example, cabling (e.g., twisted wire pair, coaxial and/or optical cabling) and/or a wireless transmission medium through an air interface (e.g., infrared and/or radio frequency medium). For example, a camera comprising a communication adapter may establish a data link with a device in a data transmission network (e.g., router 20) enabling transmission of data frames according to any one of several data transmission protocols such as, for example, versions of IEEE Std. 802.3, IEEE Std. 802.11, IEEE Std. 802.16 and/or the like. However, these are merely examples of data transmission protocols that may be used for transmission of data frames between devices in a data link and claimed subject matter is not limited in these respects.

Upon and/or in response to connection of a camera to a data transmission network at block 302, block 304 may obtain a dynamic network address (e.g., an IP address) from a host such as ISP 22. In one particular embodiment, although claimed subject matter is not limited in this respect, a computing device and/or computing platform executing process 300 may comprise one or more communication adapters to receive a dynamically assigned IP address from a domain name host for receiving an IP address according to a Dynamic Host Configuration Protocol (DHCP). In an alternative embodiment, however, a network address may be statically allocated to a camera. Nevertheless, these are merely examples of how a device may obtain a network address to enable communication with processes on a data communication network according to a communication protocol, and claimed subject matter is not limited in this respect.

Upon and/or in response to obtaining a network address at block 304, according to an embodiment, a camera may launch a server to communicate with other devices on a data transmission network. Such a server may comprise, for example, a substantially UPNP AV compliant MediaServer according to a UPnP AV architecture as identified above. Block 306 may broadcast messages containing information descriptive of the one or more aspects of a camera (e.g., camera 16 and/or camera 200) to other devices on a data transmission network such as, for example, PC 18, NAS 22 and/or media device 24 (FIG. 1). Such information may include, for example, metadata descriptive of one or more functions and/or functional abilities of a camera, an identifier associated with the camera and/or network address obtained at block 304.

In one particular embodiment, although claimed subject matter is not limited in this respect, block 306 may “advertise” the existence of the camera server using the aforementioned SSDP protocol by broadcasting one or more messages containing an obtained network address, a type identifier and a pointer to additional information to other processes on a data transmission network. In a particular embodiment, such a broadcast message may identify the camera (e.g., by name and/or location) and a capability to provide real-time image data which is based, at least in part, on images captured at the camera. Here, in a particular embodiment, a camera may indicate such capabilities by providing, for example an extensible Markup Language (XML) document and/or text document to devices on a data transmission network. However, this is merely one example of information that a camera may broadcast to other processes on a data transmission network, and claimed subject matter is not limited in this respect.

Following broadcast of messages to other devices on a data communication network at block 306, a camera may receive requests from other devices for providing image data. Such requested image data may comprise image data that is stored in a compressed and/or encoded format in a memory and/or image data that is captured at an imager in real-time. Continuing with the particular example, where a camera comprises a substantially UPnP AV compliant MediaServer, a camera may respond to requests from other devices on a data communication network such as, for example, substantially UPnP AV compliant Control Points and/or MediaRenderers for providing image data.

As pointed out above according to particular embodiments, a camera may broadcast information to descriptive of one or more functional abilities associated with the camera and/or a network address associated with the camera upon and/or in response to connecting the camera to a data transmission network. Accordingly, other devices receiving broadcasted information may discover the existence of the camera based, at least in part, on the broadcasted information including a network address associated with the camera. Using the network address obtained through discovery of the camera, devices receiving the broadcast message may transmit request messages addressed according to the network address. Accordingly, there is no need for any additional server infrastructure such as, for example, a domain name server associating domain names of devices such as a camera with network addresses.

According to an embodiment, a camera may broadcast a message at block 306 indicating one or more functional abilities and a network address upon and/or in response to being connected to a data communication network as illustrated above while other devices may be connected following such a broadcast message at block 306. A device connecting to a data transmission network may poll other devices connected to the network to, for example, to discover other devices comprising one or more functional abilities associated with the polled devices. In a particular embodiment, for example, a substantially UPnP AV.compliant Control Point may poll other devices on the network such as a substantially UPnP AV compliant MediaServer and/or MediaRenderer. Here, a camera comprising a substantially UPnP AV compliant MediaServer may respond to a poll message with information by, for example, providing a network address and/or information descriptive of one or more functional abilities of the UPnP AV compliant MediaServer. Accordingly, the polling Control Point, having discovered the camera based, at least in part, on a network address associated with the camera, may then request image data from the camera as illustrated above.

Returning to the embodiment of FIG. 1, media device 24 may comprise and/or host a substantially UPnP AV compliant MediaRenderer and/or Control Point while camera 16 may comprise a substantially UPnP AV compliant MediaServer as illustrated above. Upon discovering the MediaServer hosted on camera 16 as illustrated above, according to an IP address associated with the MediaServer, for example, media device 24 may include the discovered MediaServer in menu 28 presented on display 26. Menu 28 may identify the discovered MediaServer hosted on camera 16 by including information such as, for example, a location, capabilities of the camera (e.g., still, video and/or the like), camera make and/or model number, and/or the like along with other devices capable of providing content data for presentation. However, it should be understood that these are merely examples of information descriptive of a discovered camera that a menu may provide and claimed subject matter is not limited in these respects. Such information describing the discovered camera in the menu may be provided to media device 24 in messages from camera to media device 24 as part of the aforementioned discovery process. In one embodiment, items displayed on menu 28 may be selectable from remote control 30 for presentation of including, for example, live streamed video.

According to an embodiment, media device 24 and/or remote control 30 may comprise and/or host a substantially UPnP AV compliant Control Point capable of providing inputs to a discovered MediaServer hosted on camera 16. Accordingly, media device 24 and/or remote control 30 may transmit request messages to the discovered MediaServer to, among other things, provide content data according to a substantially compliant UPnP AV architecture. Here, for example, by making selections at media device 24 and/or remote control 30, a user may select the discovered MediaServer hosted on camera 16 to provide an image for presentation on display 26. Such an image may generated from image data received from camera 16, and provided in response to requests address to the MediaServer, which is based, at least in part, on an image captured at an imager (not shown) on camera 16 in real-time and/or image data stored in a memory.

According to an embodiment, camera 16 may be adjustably controlled in one or more aspects. For example, camera 16 may be controlled to zoom, tilt, focus, pan, alter white balance, alter contrast, alter intensity, just to name a few aspects of camera 16 that may be controllable. However, these are merely examples of aspects of camera 16 that may be adjustably controlled and claimed subject matter is not limited in this respect. In other embodiments, camera 16 may be controlled to perform other functions such as, for example taking a snapshot (e.g., by setting a time), forward captured still images or video recordings to locations on a network (e.g., by email), manually initiating a recording of captured video images, set motion triggers (e.g., for taking snap shots and/or recording video), setting alarms, and/or the like. According to an embodiment, camera 16 may be controlled to perform one or more of the above identified adjustments and/or functions by transmitting control messages to camera 16 addressed according to a network address associated with camera 16. As illustrated above, devices in system 10, such as PC 18, media device 24 and/or remote control 30 may discover camera 16 according to its network address and one or more functional abilities associated with camera 16. Accordingly, such devices may address messages to camera 16 according to its discovered network address to adjustably control one or more adjustably controllable aspects as illustrated above. In a particular embodiment, PC 18, a media device 24 and/or remote control 30, comprising and/or hosting a substantially UPnP AV compliant Control Point, may adjustably control camera 16 comprising and/or hosting a substantially UPnP AV compliant MediaServer. However, these are merely examples of how device may adjustably control aspects of a camera by addressing messages to the camera according to a network address associated with the camera, and claimed subject matter is not limited in these respects.

According to an embodiment, although claimed subject matter is not limited in this respect, camera 16 may be configured to define a path in a network through which image data captured at an imaging device, for example, is stored in a predetermined file and/or folder maintained at a different computing platform (e.g., PC 18 or NAS 22). As illustrated above, camera 16 may be controlled at a console or remotely (e.g., using media device 24 and/or remote control 30 as a substantially UPNP AV compliant Control Point). Here, camera 16 may discover file and/or folder directories on NAS 22 and/or C 18 using techniques illustrated above. A device controlling camera 16 may select one or more files and/or folders in a discovered directory to receive image data captured at an imaging device, for example.

In other embodiments, camera 16 may be adapted to capture images according to a predefined schedule and/or in response to an event. For example, camera 16 may be configured to record live video and/or snapshot images at predefined times of day and/or days of the week where captured video image data is stored in a file and/or folder defined on a mass storage device on a different computing platform such as, for example, NAS 22 and/or PC 18 as illustrated above. In other embodiments, camera 16 may be configured to record live vide and/or a snapshot images in response to events detected by, for example, remote sensing devices. Here, for example, camera 16 may be connected to sensing devices (not shown) that are capable of detecting events such as, for example, a door and/or window opening and/or closing, sounds, light sensors, pressure sensors, electrical signals and/or the like.

NAS 22 may comprise one or more file storage devices capable of storing data such as, for example, image data in any one of the aforementioned formats for storing image data. In particular, NAS 22 may define files for storing data according to a predefined file directory such as a hierarchical filed directory. According to an embodiment, camera 16 may be adapted to transmit image data to NAS 22 for storage in a file, for example. Upon being connected to a network, camera 16 may discover the existence of NAS 22 and a file directory defining a file structure on one or more file storage devices. This can be performed using any one of several techniques for sharing files on a network such as, for example, network folder sharing techniques available for versions of the Windows operating system sold by Microsoft, Inc. Here, one or more directories of files defined on NAS 22 may be mapped as a local file storage device and/or drive, enabling applications hosted on camera 16 to store image data to a directory of NAS 22 as if these directories were defined on a file storage device local to camera 16. Camera 16 may similarly map a file storage device maintained on PC 18 as a file storage device that is local to camera 16 for storage as illustrated above for NAS 22. It should be understood, however, that these are merely examples of how a file storage device connected to a camera over a data transmission network may be configured to act as a local file storage device for the camera, and claimed subject matter is not limited in these respects.

According to an embodiment, although claimed subject matter is not limited in this respect, camera 16 may be adjustably controlled to define a mass storage device of a different device (e.g., a mass storage device accessible through NAS 22 and/or PC 18) as a local mass storage device as illustrated above. As illustrated above, other devices in system 10 may transmit messages to camera 16 (e.g., media device 24 and/or remote control 30) addressed to a network address associated with camera to adjustably control camera 16. In a similar fashion, such messages from other devices in system 10 may be used to configure camera 16 to define a mass storage device at another device connected to camera 16 over a data transmission network. However, this is merely an example of how a mass storage device may be available to store image data from a camera and claimed subject matter is not limited in this respect.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of claims, and equivalents thereof.

What is claimed is:

1. A camera comprising:
a communication adapter to transmit information to and/or receive information from a data communication network;
an imager to capture images; and
circuitry to generate content data based, at least in part, on said captured images,
wherein said camera is discoverable on said data communication network according to a network address associated with said camera.

2. The camera of claim 1, wherein said data communication network comprises a local network and wherein said camera is discoverable according to a network discovery protocol.

3. The camera of claim 1, wherein said camera is discoverable according to an SDDP protocol.

4. The camera of claim 1, wherein said network address comprises an Internet Protocol (IP) address.

5. The camera of claim 4, wherein said camera is adapted to obtain said IP address according to a DHCP protocol.

6. The camera of claim 1, wherein said camera is further adapted to transmit said content data to one or more client devices in responses messages addressed according to said discovered network address.

7. The camera of claim 6, wherein said server is capable of transmitting said content data to said one or more client devices in packets addressed to said one or more client devices according to one or more IP addresses associated with said one or more client devices.

8. The camera of claim 1, and further comprising:
readout circuitry to transfer signals representative of said captured images from said imager; and
an encoder to process said transferred signals to provide said stored content data.

9. The camera of claim 8, wherein said encoder is capable of encoding said content data in a substantially MPEG compliant format.

10. The camera of claim 1, wherein said camera is adapted to host a substantially UPnP AV compliant MediaServer associated with said network address.

11. The camera of claim 10, wherein said substantially UPnP AV compliant MediaServer is capable of transmitting said content data to one or more client devices in response to one or more messages from one or more substantially UPnP compliant Control Points.

12. The camera of claim 10, wherein said one or more client devices comprise one or more substantially UPnP AV compliant MediaRenderers.

13. A system comprising:
a camera, said camera comprising a communication adapter adapted for connecting to a data transmission network and logic adapted to receive information from said data communication network addressed according to a network address associated with said camera; and
a media device capable of being adapted for connecting to said data transmission network and comprising logic to associate to discover said camera on said network,
wherein said camera is discoverable by said media device according to said network address in response to at least one of a connection of said camera to said data communication network and/or connection of said media device to said data transmission network.

14. The system of claim 13, wherein said camera further comprises logic to broadcast said network address to one or more devices in response to connection of said camera to said data communication network, and wherein said media device is capable of discovering said camera based, at least in part, on said broadcasted network address.

15. The system of claim 14, wherein said camera further comprises logic to broadcast information descriptive of one or more functional abilities of said camera to one or more device in response to said connection of said camera to said data network, and wherein said media device is capable of discovering said camera based, at least in part, on said broadcasted information descriptive of said one or more functional abilities.

16. The system of claim 13, wherein said camera comprises logic to provide said network address to said media device in response to a poll signal from said media device.

17. The system of claim 13, wherein said camera comprises logic to transit one or messages comprising information descriptive of at least one functional ability of said camera to said media device in response to a poll signal from said media device.

18. The system of claim 13, wherein said media device comprises logic to poll devices on said data transmission network in response to connection of said media device to said network, and wherein said camera further comprises logic to transmit said network address to said media device in response to said poll.

19. The system of claim 13, wherein said media device is capable of rendering images on a display in response to content data, and wherein said media device is capable of rendering a menu on said display including information identifying said camera in response to discovery of said camera by said media device.

20. An article comprising:
a storage medium comprising machine-readable instructions stored thereon to:
obtain a network address associated with a camera in response to connection of said camera to a data transmission network;
enable discovery of said camera by one or more other devices connected to said data transmission network based, at least in part, on said network address; and
stream image data captured at said camera to at least one of said one or more other devices in response to receipt of at least one message addressed according to said network address.

21. The article of claim 20, wherein said storage medium further comprises machine-readable instructions stored thereon to broadcast said network address to said one or more other devices.

22. The article of claim 21, wherein said storage medium further comprises machine-readable instructions stored thereon to broadcast information descriptive of one or more functional abilities associated with said camera to said one or more other devices.

23. The article of claim 20, wherein said storage medium further comprises machine-readable instructions stored thereon to transmit said network address to at least one of said one or more other devices in response to a poll message from said at least one of said one or more other devices.

23. The article of claim 22, wherein said storage medium further comprises machine-readable instructions stored thereon to transmit information descriptive of one or more functional abilities of said camera in response to said poll message.

24. The article of claim 20, wherein said storage medium further comprises machine-readable instructions stored thereon to control said camera in response to one or more messages addressed according to said network address.

25. The article of claim 24, wherein said storage medium further comprises machine-readable instructions stored thereon to adjustably control one or more of zoom, tilt, focus and/or pan of said camera in response to said one or more messages.

26. The article of claim 24, wherein said storage medium further comprises machine-readable instructions stored thereon to said camera to perform one or more functions in response to said one or messages.

27. The article of claim 26, wherein said one or more functions comprises taking a snapshot.

28. The article of claim 26, wherein said one or more functions comprises forwarding captured still images and/or video recordings to a destination on a network taking a snapshot.

29. The article of claim 26, wherein said one or more functions comprises setting a motion trigger.

30. The article of claim 26, wherein said one or more functions comprises initiating a video recording of captured images.
